(19) United States
(12) Patent Application Publication
(10) Pub. No.: US 2009/0308191 A1
(43) Pub. Date: Dec. 17, 2009

(54) LIFTING MOTOR DRIVE

(75) Inventors: HSIEN-TE TSENG, CHIUNG-LIN TOWNSHIP (TW); CHUN-CHIH LIU, SIJHIH CITY (TW)

Correspondence Address: MOTECK ELECTRIC CORP., P.O. BOX 108-00403, TAIPEI, 106, omitted

(73) Assignee: MOTECK ELECTRIC CORP., SIJHIH CITY (TW)

(21) Appl. No.: 12/480,707

(22) Filed: Jun. 9, 2009

(30) Foreign Application Priority Data
Jun. 11, 2008 (TW) 097210353

(51) Int. Cl. H02K 7/116

(52) U.S. Cl. 74/421 A

(57) ABSTRACT

A lifting motor drive includes a gearbox housing, a transmission shaft mounted inside the gearbox housing and having a first connector at one side for the connection of an external object to be moved by the transmission shaft and a second connector at the other side for the connection of a crank handle for allowing rotation of the transmission shaft manually by a user, a motor for rotating the transmission shaft through a driving gear and a driven gear, and a thermistor, which detects the working temperature of the motor and cuts off power supply from the motor when the working temperature of the motor surpasses a predetermined temperature level.

This application claims the priority benefit of Taiwan patent application number 097210353 filed on Jun. 11, 2008.

### BACKGROUND OF THE INVENTION

1. Field of the Invention

The present invention relates to a motor drive and more particularly, to a lifting motor drive, which utilizes a thermistor to detect the working temperature of the motor and to cut off power supply from the motor when overheat.

2. Description of the Related Art

A lifting motor drive is usually used to lift a lifting jack, to move the folding rack of a hospital bed or machine, to move a steel rolling door or sliding door either directly or through transmission means. The motor of a lifting motor drive is normally kept from sight. During operation, the working temperature of the motor rises. When the motor keeps working upon an overheat, the high temperature may cause the motor to burn out. Further, when a motor damaged, it takes much time and labor to find the problem and to repair the damage. Further, limit switches are commonly used and installed in the start point and the end point. When the driven mechanism reaches the start or end point and touches one limit switch, the respective limit switch cuts off power supply from the motor, preventing an overload. Because the limit switches are exposed to the outside, they tend to be damaged accidentally. Further, the arrangement of the electric wiring of the limit switches is another problem to be cared.

Therefore, it is desirable to provide a lifting motor drive that eliminates the aforesaid problems.

### SUMMARY OF THE INVENTION

The present invention has been accomplished under the circumstances in view. It is one object of the present invention to provide a lifting motor drive, which automatically cuts off power supply from the motor when overheat. It is another object of the present invention to provide a lifting motor drive, which allows arrangement of the transmission shaft selectively in one of two reversed directions to fit different requirements. It is still another object of the present invention to provide a lifting motor drive, which is operable manually upon power failure or motor failure.

To achieve these and other objects of the present invention, the lifting motor drive comprises a gearbox housing, a transmission shaft mounted inside the gearbox housing and having a first connector at one side for the connection of an external object to be moved by the transmission shaft and a second connector at the other side for the connection of a crank handle for allowing rotation of the transmission shaft manually by a user, a motor for rotating the transmission shaft through a driving gear and a driven gear, and a thermistor, which detects the working temperature of the motor and cuts off power supply from the motor when the working temperature of the motor surpasses a predetermined temperature level.

Further, the installation direction of the transmission shaft in the gearbox housing can be reversed, i.e., the transmission shaft can be installed in the gearbox housing in one of two reversed directions for enabling the first connector to connect a left-handed screw rod or a right-handed screw rod.

Further, the first connector and the second connector can be disposed inside the gearbox housing and respectively aimed at a front opening and a rear opening of the gearbox housing. Alternatively, the first connector and the second connector can be respectively affixed to the two distal ends of the transmission shaft and extended out of the front opening and the rear opening of the gearbox housing.

### BRIEF DESCRIPTION OF THE DRAWINGS

FIG. 1 is an elevational view of a lifting motor drive in accordance with the present invention.

FIG. 2 is an exploded view of the lifting motor drive in accordance with the present invention.

FIG. 3 is a sectional side view of the lifting motor drive in accordance with the present invention.

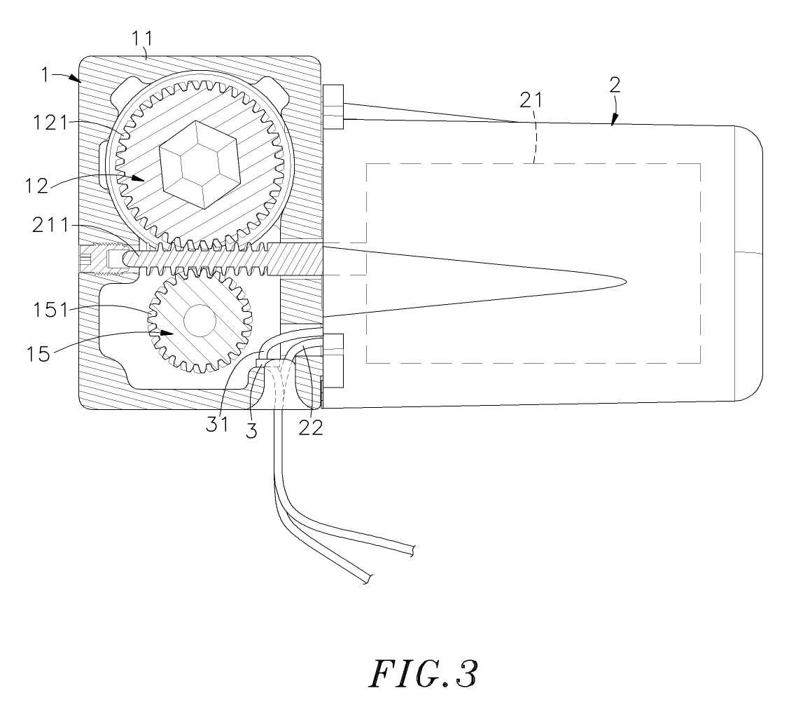

FIG. 4 is a sectional view of the present invention, showing the internal arrangement of the gearbox.

FIG. 5 illustrates an application example of the lifting motor drive according to the present invention.

FIG. 6 is a schematic perspective view of the present invention, showing a crank handle attached to the second connector of the transmission shaft.

FIG. 7 is a sectional view of the gearbox of the lifting motor drive according to the present invention, showing the installation direction of the transmission shaft and the stabilizer reversed.

FIG. 8 is a sectional view of an alternate form of the gearbox, showing the first connector and the second connector connected arranged at the two distal ends of the transmission shaft body and disposed inside the accommodation chamber of the housing of the gearbox.

### DETAILED DESCRIPTION OF THE PREFERRED EMBODIMENT

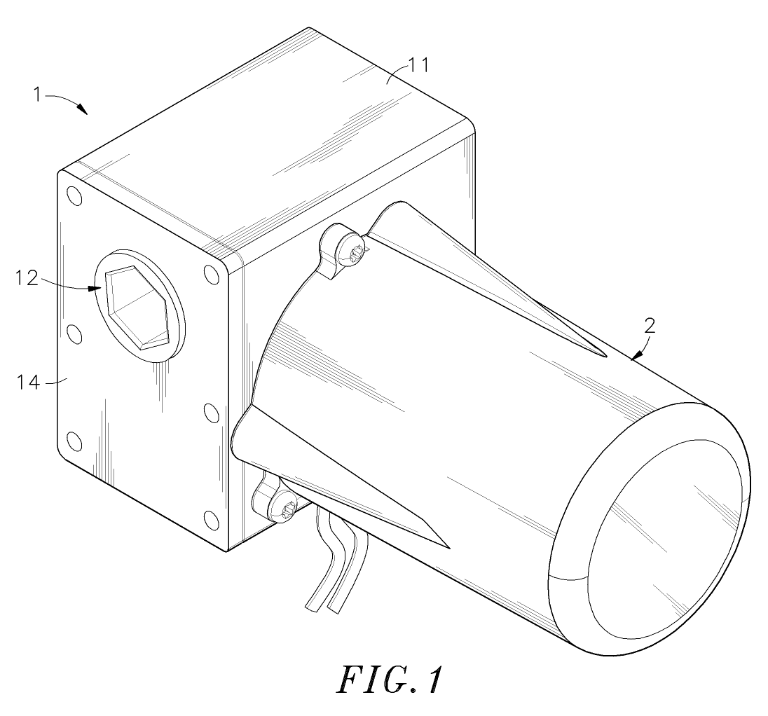

Referring to FIGS. 1˜3, a lifting motor drive in accordance with the present invention is shown comprising a gearbox 1, a motor 2, and a thermistor 3.

The gearbox 1 comprises a housing 11. The housing 11 has an accommodation chamber 10 defined therein, a rear opening 112 located on the rear close side of the accommodation chamber 10, a front cover 14 covered on the front open side of the accommodation chamber 10, a front opening 111 located on the front cover 14 in axial alignment with the rear opening 112, a packing member 13 set in between the front cover 14 and the border area of the front open side of the accommodation chamber 10, a side axle hole 16 located on one lateral sidewall thereof in communication with the accommodation chamber 10 and extending in direction perpendicular to the axis passing through the front opening 111 and the rear opening 112, and a motor mount 17 protruded from the lateral sidewall around the side axle hole 16. The gearbox 1 further has a transmission shaft 12 and a stabilizer 15 mounted in the accommodation chamber 10 at different elevations in a parallel manner. The transmission shaft 12 has a transmission shaft body 120, a driven gear 121 formed integral with the periphery of the middle part of the transmission shaft body 120, a first connector 122, which can be, for example, a hexagonal socket, fixedly provided at one end of the transmission shaft body 120, a second connector 123, which can be, for example, a hexagonal rod, fixedly provided at the other end of the transmission shaft body 120, and two bearings 124 mounted in the accommodation chamber 10 of the housing 11 around the two distal ends of the transmission shaft body 120 to support the transmission shaft body 120 in the accommodation chamber 10 for smooth rotation. After installation of the transmission shaft 12 in the housing 11, the first connector 122 and the second connector 123 respectively extend out of the front opening 111 and rear opening 112 of the housing 11. The stabilizer 15 comprises an axle 152 mounted inside the accommodation chamber 10 of the housing 11, a stabilizing gear 151 mounted on the axle 152 and disposed adjacent to the driven gear 121, and two bearings 153 mounted on the axle 152 at two sides of the stabilizing gear 151 and adapted to smoothen rotation of the stabilizing gear 151.

The motor 2 has driving means, for example, a driving screw 211 extended out of one side of the motor housing 21 thereof, and a power cord 22 for connection to an electric outlet to obtain the necessary working voltage. Further, the driving screw 211 can be formed integral with the output shaft of the motor 2.

The thermistor 3 has a lead wire 31 electrically connected to the power cord 22 of the motor 2.

During installation of the lifting motor drive, insert the threaded output shaft 21 into the side axle hole 16 of the housing 11 and affix the motor 2 to the motor mount 17 on the outside of the housing 11, keeping the threaded output shaft 21 meshed in between the driven gear 121 of the transmission shaft 12 and the stabilizing gear 151 of the stabilizer 15, and then connect the lead wire 31 of the thermistor 3 and the power cord 22 of the motor 2 in series to an external electric outlet (not shown) to obtain the necessary working voltage.

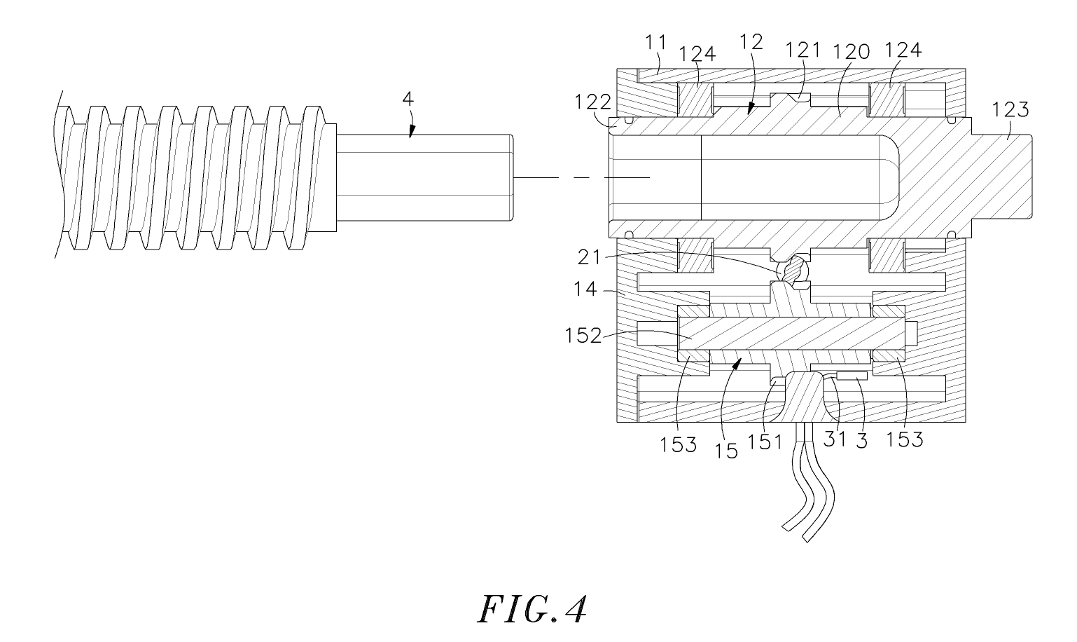

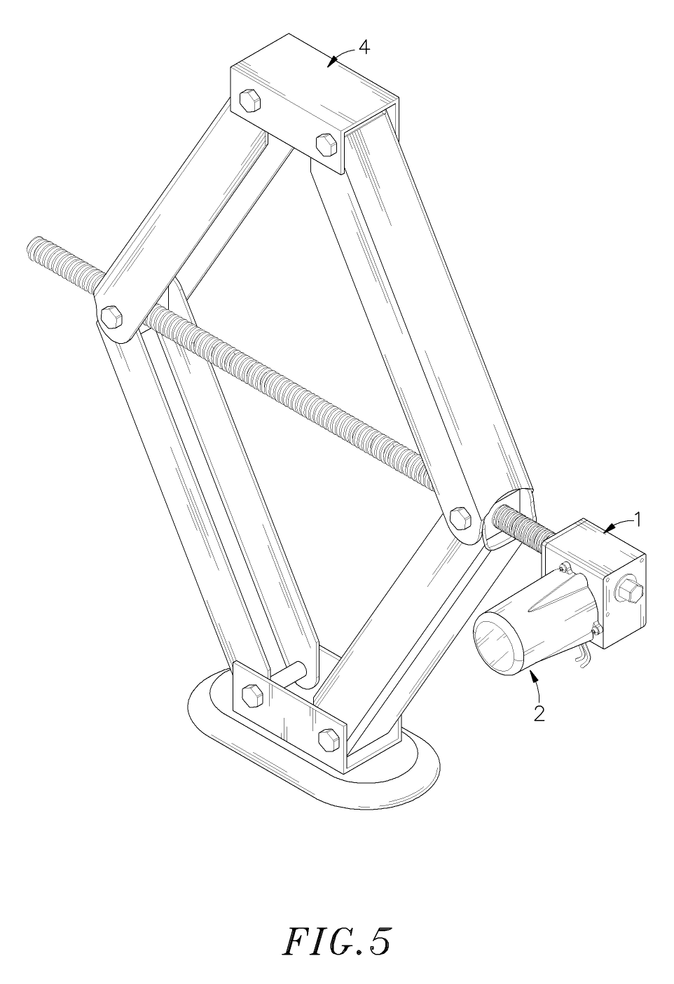

Referring to FIGS. 4 and 5, when started up the motor 2, the driving screw 211 is driven to rotate the driven gear 121 and the transmission shaft body 120, causing the first connector 122 to rotate the connected an external object 4 (see FIGS. 4 and 5). The external object 4 can be a lifting jack, the driving screw rod of the folding rack of a hospital bed, the folding rack of a machine, or the driving member of a rolling steel door or electric sliding door. During rotation of the driven gear 121 by the driving screw 211, the stabilizing gear 151 is rotated by the driving screw 211 in direction reversed to the driven gear 121, stabilizing stable and smooth rotation of the driving screw 211 and the driven gear 121. Therefore, the stabilizer 15 prohibits the transmission shaft 12 from biasing during operation of the motor 2. Further, when the external object is moved to the start point or end point, power supply will be automatically cut off from the motor 2 without the control of any limit switch means (this will be explained further). Therefore, when the external object 4 reaches the desired position, the lifting motor drive will soon be stopped, avoiding displacement of the external object 4.

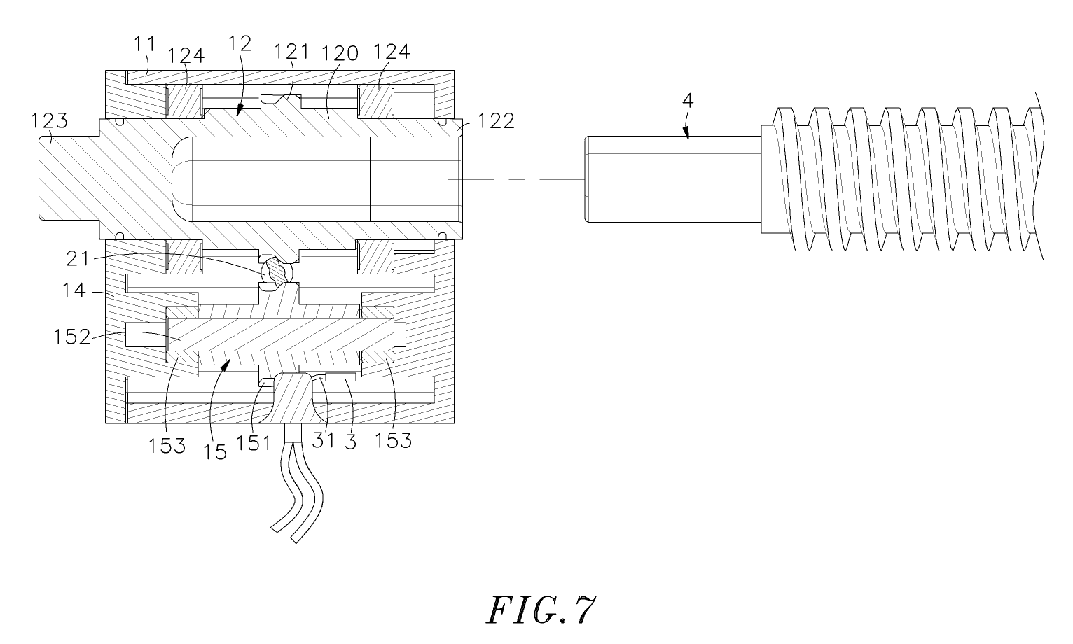

Referring to FIG. 7 and FIG. 4 again, the installation direction of the transmission shaft 12 and the stabilizer 15 in the housing 11 can be reversed to fit different requirements, widening the application. For example, the transmission shaft 12 and the stabilizer 15 can be installed in the housing 11 in a first direction to rotate a right-handed screw rod (see FIG. 4), or a second direction reversed to the first direction to rotate a left-handed screw rod (see FIG. 7).

Further, when the transmission shaft 12 moves the external object 4 to one of two reversed limit positions, the electric current at the motor 2 rises rapidly, causing a sharp temperature rise. When the temperature sensed by the thermistor 3 surpassed the predetermined value, the thermistor 3 immediately cuts off electric current, thereby stopping the motor 2. By means of the functioning of the thermistor 3, no any extra limit switch means for controlling the operation of the motor 2 is necessary. Further, two or more transmission shafts 12 may be installed in the accommodation chamber 10 of the housing 11 and coupled together in a parallel manner for driving multiple external objects 4 by the motor 2 that has its driving screw 211 meshed in between the stabilizing gear 151 and the driven gear 121 of one transmission shaft 12.

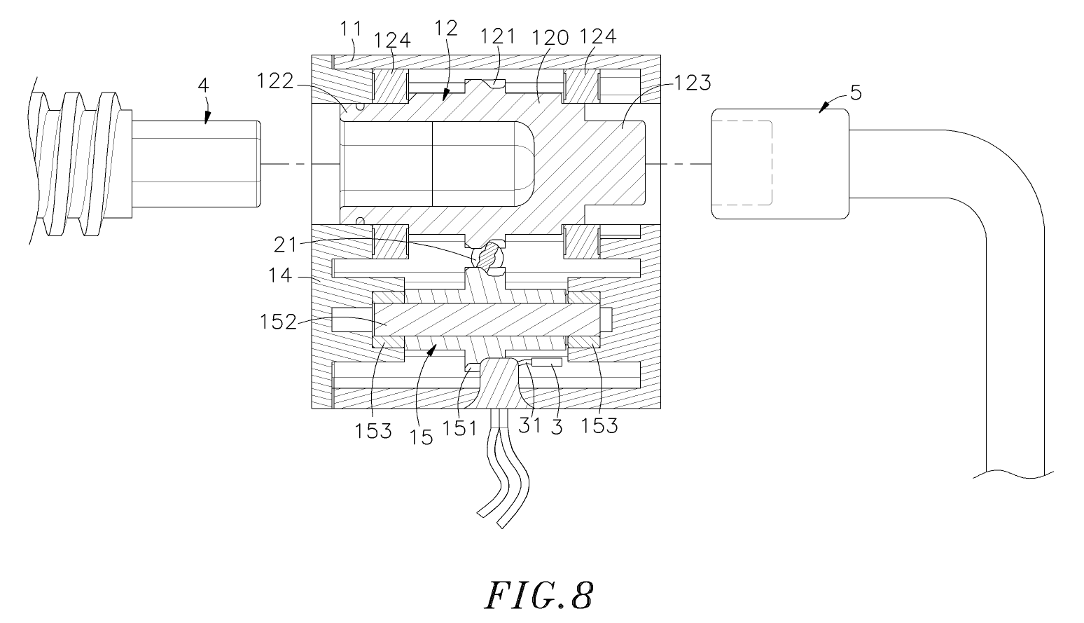

Referring to FIG. 8, the transmission shaft body 120 can be made relatively shorter so that the first connector 122 and the second connector 123 are kept inside the accommodation chamber 10 in the housing 11 and respectively aimed at the front opening 111 and rear opening 112 of the housing 11.

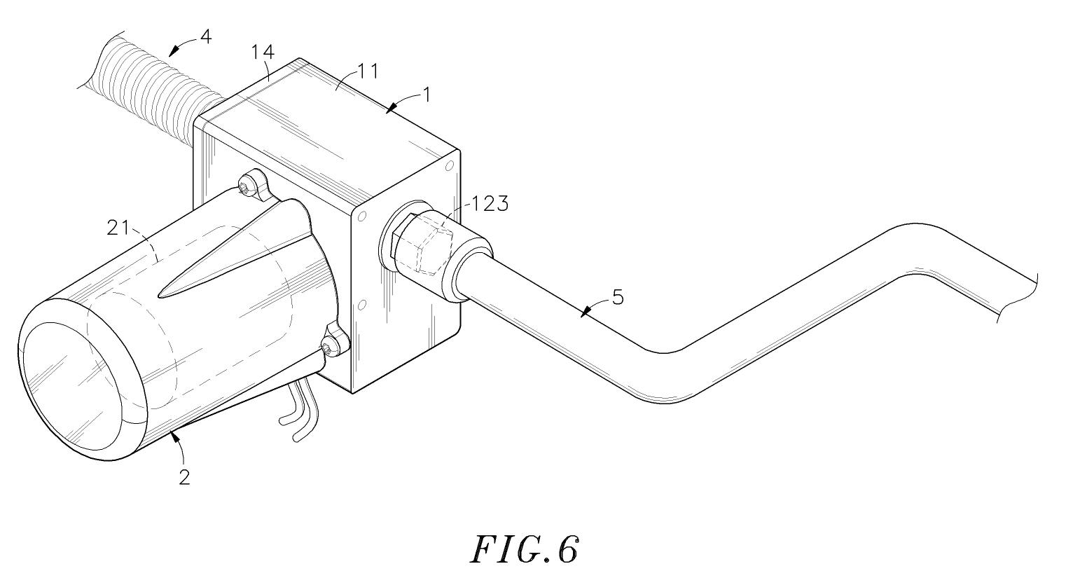

Referring to FIGS. 6 and 8, when power failed or when the motor 2 failed, a hand tool, for example, crank handle 5 can be attached to the second connector 123 and operated to rotate the attached external object 4 manually. Thus, the invention allows operation automatically as well as manually.

Referring to FIGS. 1˜8 again, the driven gear 121 of the transmission shaft 12 and the stabilizing gear 151 can be gears, and the driving screw 211 of the motor 2 can be a worm. Alternatively, any other gear or belt transmission means may be employed to achieve transmission of rotary driving force from the motor 2 to the transmission shaft body 120 of the transmission shaft 12. Further, the power cord 22 of the motor 2 and the lead wire 31 of the thermistor 3 are connected in series. When the temperature of the motor 2 surpasses a predetermined temperature level, the thermistor 3 immediately cuts off power supply from the motor 2. On the contrary, when the temperature of the motor 2 is under the predetermined temperature level, the thermistor 3 allows connection of power supply to the motor 2. Therefore, the invention avoids motor burnout due to an excessively high working temperature, saving much maintenance cost and time.

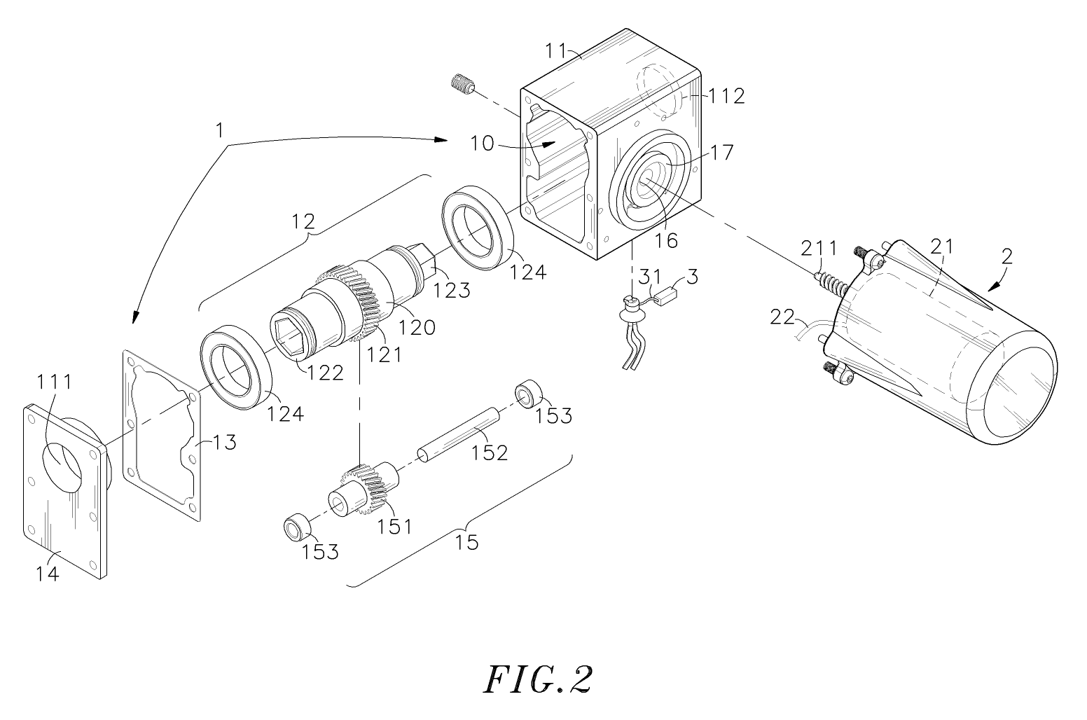

Referring to FIGS. 2˜6 again, the first connector 122 and the second connector 123 are respectively fixedly provided at the two distal ends of the transmission shaft body 120 in axial alignment, and respectively extending out of the front opening 111 and rear opening 112 of the housing 11 for the connection of an external object 4 and a hand tool 5 such that the external object 4 can be rotated automatically by the motor 2, or manually by the hand tool 5. Because the first connector 122 and the second connector 123 are kept in perfect axial alignment, the transmission shaft 12 and the attached external object 4 can be rotated smoothly.

As stated above, the invention connects the power cord 22 of the motor 2 and the lead wire 31 of the thermistor 3 in series to power source. During operation of the motor 2, the thermistor 3 detects the working temperature of the motor 2. When the working temperature of the motor 2 surpasses a predetermined temperature level, the thermistor 3 immediately cuts off power supply from the motor 2, avoiding motor burnout.

In general, the invention provides a lifting motor drive, which has the following advantages and features:

1. The power cord 22 of the motor 2 and the lead wire 31 of the thermistor 3 are connected in series to power source. During operation of the motor 2, the thermistor 3 detects the working temperature of the motor 2. When the working temperature of the motor 2 surpasses a predetermined temperature level, the thermistor 3 immediately cuts off power supply from the motor 2, avoiding motor burnout. When the working temperature drops below the predetermined temperature level, the thermistor 3 allows connection of power supply to the motor 2 again. Therefore, the attached object 4 is moved to the start point or end point, the motor 2 is stopped. By means of the functioning of the thermistor 3, no any extra limit switch means is necessary.

2. By means of the functioning of the thermistor 3 to detect the working temperature of the motor 2 and to cut off power supply from the motor 2 automatically when the working temperature surpasses a predetermined temperature level. Therefore, no any limit switch is necessary to control the operation of the motor 2.

3. The transmission shaft 12 and the stabilizer 15 can be arranged in the housing 11 selectively in one of two reversed directions to fit different requirements.

A prototype of lifting motor drive has been constructed with the features of FIGS. 1˜8. The lifting motor drive functions smoothly to provide all of the features disclosed earlier.

Although particular embodiments of the invention have been described in detail for purposes of illustration, various modifications and enhancements may be made without departing from the spirit and scope of the invention. For example, any resistor means, such as PTC or positive temperature coefficient means, whose resistance varies with temperature may be used to substitute for the thermistor 3. Accordingly, the invention is not to be limited except as by the appended claims.

What the invention claimed is:

1. A lifting motor drive, comprising:
a gearbox housing, said gearbox housing having an accommodation chamber defined therein, a front opening disposed at a front side relative to said accommodation chamber, rear opening disposed at a rear side relative to said accommodation chamber, a side axle hole located on one lateral sidewall thereof in communication with the accommodation chamber and extending in direction perpendicular to the axis of said front opening and said rear opening, and a motor mount protruded from the lateral sidewall around said side axle hole;
a transmission shaft mounted in said accommodation chamber between said front opening and said rear opening;
a first connector fixedly located on a front end of said transmission shaft corresponding to said front opening of said gearbox housing;
a second connector fixedly located on a rear end of said transmission shaft opposite to said front end and corresponding to said rear opening of said gearbox housing;
a motor fixedly mounted on said motor mount outside said gearbox housing and adapted for rotating said transmission shaft;
a driving member rotatable by said motor;
a driven member mounted on said transmission shaft and meshed with said driving member for enabling said transmission shaft to be rotated by said motor through said driving member; and
a thermistor electrically connected in series to said motor and adapted for detecting the working temperature of said motor and to cut off power supply from said motor when the working temperature of said motor surpasses a predetermined temperature level.

2. The lifting motor drive as claimed in claim 1, wherein said gearbox housing has a front cover covered on a front open side thereof and a packing member set in between said front cover and the border of said front open side.

3. The lifting motor drive as claimed in claim 2, wherein said front opening of said gearbox housing is located on said front cover and kept in axial alignment with said rear opening.

4. The lifting motor drive as claimed in claim 1, further comprising an operating tool detachably attached to said second connector for operation by a user to rotate said transmission shaft manually.

5. The lifting motor drive as claimed in claim 1, wherein said driving member is a driving gear axially formed integral with the output shaft of said motor; said driven member is a driven gear formed integral with the periphery of said transmission shaft and meshed with said driving gear.

6. The lifting motor drive as claimed in claim 1, wherein said first connector and said second connector are respectively fixedly mounted on the front and rear ends of said transmission shaft and respectively extended out of said front opening and said rear opening of said gearbox housing.

7. The lifting motor drive as claimed in claim 1, wherein said first connector and said second connector are respectively fixedly mounted on the front and rear ends of said transmission shaft and disposed inside said accommodation chamber and respectively aimed at said front opening and said rear opening of said gearbox housing.

8. The lifting motor drive as claimed in claim 1, further comprising bearing means adapted to support said transmission shaft inside said gearbox housing.

9. The lifting motor drive as claimed in claim 1, further comprising a stabilizer mounted in said accommodation chamber of said gearbox housing and adapted to stabilize rotation of said transmission shaft and said driving member, said stabilizer comprising an axle supported on bearing means inside said accommodation chamber of said gearbox housing, a stabilizing wheel mounted on said axle and meshed with said driving member at one side opposite to said driven member.

10. The lifting motor drive as claimed in claim 1, further comprising at least one sub-transmission shaft mounted in said accommodation chamber of said gearbox housing and coupled to said transmission shaft in a parallel manner for rotating a respective external object.

11. A lifting motor drive, comprising:
a gearbox housing, said gearbox housing having an accommodation chamber defined therein, a front opening disposed at a front side relative to said accommodation chamber, rear opening disposed at a rear side relative to said accommodation chamber, a side axle hole located on one lateral sidewall thereof in communication with the accommodation chamber and extending in direction perpendicular to the axis of said front opening and said rear opening, and a motor mount protruded from the lateral sidewall around said side axle hole;
a transmission shaft mounted in said accommodation chamber between said front opening and said rear opening;
a first connector fixedly located on a front end of said transmission shaft corresponding to said front opening of said gearbox housing;
a second connector fixedly located on a rear end of said transmission shaft opposite to said front end and corresponding to said rear opening of said gearbox housing;
a motor fixedly mounted on said motor mount outside said gearbox housing and adapted for rotating said transmission shaft;
a driving member rotatable by said motor;
a driven member mounted on said transmission shaft and meshed with said driving member for enabling said transmission shaft to be rotated by said motor through said driving member;
a stabilizer mounted in said accommodation chamber of said gearbox housing and adapted to stabilize rotation of said transmission shaft and said driving member, said stabilizer comprising an axle supported on bearing means inside said accommodation chamber of said gearbox housing, a stabilizing wheel mounted on said axle and meshed with said driving member at one side opposite to said driven member.
a driven mechanism coupled to said second connector movable by said transmission shaft between a start position and an end position; and
a thermistor electrically connected in series to said motor and adapted for detecting the working temperature of said motor and to cut off power supply from said motor when the working temperature of said motor surpasses a predetermined temperature level.

12. The lifting motor drive as claimed in claim 11, wherein said gearbox housing has a front cover covered on a front open side thereof and a packing member set in between said front cover and the border of said front open side.

13. The lifting motor drive as claimed in claim 12, wherein said front opening of said gearbox housing is located on said front cover and kept in axial alignment with said rear opening.

14. The lifting motor drive as claimed in claim 11, further comprising an operating tool detachably attached to said second connector for operation by a user to rotate said transmission shaft manually.

15. The lifting motor drive as claimed in claim 11, wherein said driving member is a driving gear axially formed integral with the output shaft of said motor; said driven member is a driven gear formed integral with the periphery of said transmission shaft and meshed with said driving gear.

16. The lifting motor drive as claimed in claim 11, wherein said first connector and said second connector are respectively fixedly mounted on the front and rear ends of said transmission shaft and respectively extended out of said front opening and said rear opening of said gearbox housing.

17. The lifting motor drive as claimed in claim 11, wherein said first connector and said second connector are respectively fixedly mounted on the front and rear ends of said transmission shaft and disposed inside said accommodation chamber and respectively aimed at said front opening and said rear opening of said gearbox housing.

18. The lifting motor drive as claimed in claim 11, further comprising bearing means adapted to support said transmission shaft and said axle inside said gearbox housing.

19. The lifting motor drive as claimed in claim 11, wherein said driven mechanism is a lifting jack.

20. The lifting motor drive as claimed in claim 11, wherein said driven mechanism is a folding rack of a mechanical apparatus.
